(19) United States
(12) Patent Application Publication
(10) Pub. No.: US 2013/0227429 A1
(43) Pub. Date: Aug. 29, 2013

(54) Method and tool for data collection, processing, search and display

(71) Applicant: Kulangara Sivadas, Foothill Ranch, CA (US)

(72) Inventor: Kulangara Sivadas, Foothill Ranch, CA (US)

(21) Appl. No.: 13/507,683

(22) Filed: Jul. 19, 2012

Related U.S. Application Data
(60) Provisional application No. 61/634,300, filed on Feb. 27, 2012.

(51) Int. Cl. G06F 3/048

(52) U.S. Cl. 715/751

(57) ABSTRACT

A social data network tool to collect (110), compile, analyze, graph (210) and search (230) data elements submitted by individual entities, has software modules and enabling hardware components that facilitate forming data sharing groups. A data sharing group serves as a mutually supporting and benefiting community where highly dependable data of common interest are securely shared, displayed, compared and analyzed. A Data-Discrepancy-Analysis tool (420) available on the Graphical User Interface (400), helps users with explanations on similarities or differences between data series, sets or groups. A slew of mathematical algorithms, external databases and domain experts assist the tool to reveal, quantify and interpret trends in data structures for the benefit of users. A high efficiency data mining engine is also part of this tool, which is designed to search (203) for numerical characteristics of data series or their numerical relationships with other data series or their associated storage tags.

### CROSS REFERENCE TO RELATED APPLICATIONS

This application claims the benefit of PPA Ser. No. 61/634,300 filed on Feb. 27, 2012 by the present inventor, which is incorporated by reference.

### BACKGROUND

### Prior Art

The following is a tabulation of some prior art that presently appears relevant:

| | | U.S. Patents Pub/ | |
|---|---|---|---|
| Patent Number | Kind Code | Issue Date | Patentee |
| 0,215,945 | A1 | 2011 Sep. 08 | Peleg et al. |
| 0,109,158 | A1 | 2008 May 08 | Huhtala et al. |
| 0,313,915 | A1 | 2011 Dec. 22 | Tang |
| 0,313,102 | A1 | 2009 Dec. 17 | Le Roy et al. |
| 0,044,588 | A1 | 2001 Nov. 22 | Mault |
| 0,020,424 | A1 | 2006 Jan. 26 | Quindel |
| 0,270,778 | A1 | 2011 Nov. 03 | Mondal |
| 0,101,841 | A9 | 2005 May 12 | Kaylor et al. |
| 0,179,640 | A1 | 2007 Aug 02 | Moughler |
| 0,153,740 | A1 | 2011 Jun. 23 | Smith et al. |
| 0,010,384 | A1 | 2011 Jan. 13 | Luo et al. |
| 0,225,293 | A1 | 2011 Sep. 15 | Rathod |
| 0,260,860 | A1 | 2011 Oct. 27 | Gupta |
| 0,306,985 | A1 | 2008 Dec. 11 | Murray et al. |

In our lives, there are umpteen things about us that we wish to compare against others. For example, a retiring employee would want to know how his/her investment portfolio has been faring against peers in the past couple of years. In another scenario, a person under a maintenance medication might be concerned how a certain side-effect he/she feels, or a blood-work diagnostic, compares with other patients undergoing similar or alternative treatments on a daily basis. If you're an athlete or a body builder, you would compare your vitality numbers or workout numbers against peers on a periodic basis. Or you could be a work-commuter, wanting to know how your commute-time varies from other commuters who start at different times of the day or use alternate routes, to the same destination.

In the current financial market, you would typically know about a fund's performance only if you subscribe to that fund. Even if you happen to subscribe to various types of funds, you still may not get a truly global perspective of stock markets vs. bond markets vs. money markets, or have a real-time statistic between gold futures vs. real estate investments from a handful of fund managers. Neither does it really help to know from a belated Wall Street Journal report, that bond funds indeed performed better than stock funds last year! And most importantly, how do you know if the stock-picks by your fund-manager haven't been as smart as your peer's who had similar risk tolerance and investment objectives as you did?

In situations such as the ones described above, since published data isn't always available, believable or up-to-date, you'll be tempted to solicit information directly in your neighborhood, community, among relatives etc. A major setback to this approach is that, data sampled from a few personal contacts would not form a sizeable enough population to draw statistical conclusions from. Also you'll be reluctant to ask inquisitive, personal questions even to close friends, wary of jeopardizing relationships. Such a large-scale, data gathering operation managed across a swath of communities will require a tool that guarantees user privacy, ensures data integrity, and operates with ease.

To summarize, there hasn't been that kind of a tool out there, such as a software app running on a smart phone or PC that can collect data from willing participants, compile, process and display them in easy-to-follow graphic for the benefit of such participants, while protecting the confidentiality of people involved.

For example, prior arts US 2005/0101841 A9, US 2007/0179640 A1 and US 2001/0044588 A1 disclose technologies to transmit numerical measurement-data over a network, however the issue of group-sharing such data isn't adequately addressed. Whereas, patent applications US 2011/0153740 A1, US 2011/0225293 A1 and US 2011/0010384 A1 do discuss forming of information sharing groups, but such information is not quantifiable and hence can't be numerically compared. In US 2011/0270778 A1 and US 2009/0313102 A1, technology to share and compare quantifiable data is discussed. However, the data contributors are not users themselves in this case. Patent application US 2006/0020424 A1 on the other hand, discusses data comparison, quantitative analysis of data, historical trend-retrieval and many advanced data comparison features, but the technology proposed is not for sharing the results among a group.

Finally, prior art US 2011/0313915 A1 discloses a tool that can be used to share quantifiable data among networked groups. However, the data sources are devices (not individuals) which need to be registered with the system. Also such registrations, device groupings, data handling etc are not actively administered by a user individual. Besides, the main objective of the tool disclosed there is aggregation of user data for monetizing or otherwise. It is not a tool for differentiating between data streams or comparative characterization of data series. The foregoing discussion describes how my present invention is able to fill-in the gap revealed above.

### SUMMARY & OBJECTIVES

The invention disclosed here is a tool and method for data gathering, searching, processing, interpreting and display. In the foregoing discussion, this tool is also referred to as ‘the system’. It has the following main parts and functions:

(1) A front-end, user-interactive software component that runs on client computing platforms such as handhelds, PCs, laptops etc that can guide an entity (user) thro' appropriate menus to setup a data sharing group, manage user-profiles, submit data elements along with time-stamps, geo-location stamps or any independent parameter such data may be associated with (if applicable), submit further information regarding how the user wants the data to be processed and analyzed, communicate with severs to get the data processed in a manner preferred by the user and display the processed results to the user in the preferred graphic format.

(2) An interactive feature on the client machine which works in tandem with server machines and associated resources, that helps the user find internet users having similar data sharing objectives, solicit their membership into the proposed data sharing group using various media, and control admittances into said group based on solicitor's profile, reliability history, data submission objective etc.

(3) An additional user-interactive, client interface that enables users to control their privacy settings with regard to sharing their data & profile within a user group, with system/knowledge-domain administrators or to search engines.

(4) A server computer centrally connected and communicatively coupled to multiple of such client platforms, capable of assisting such client platforms in soliciting new members, setting up member profiles and managing groups to the liking of the stake-holders of the data sharing group, authenticating member log-ins, collecting data elements and associated parametric elements (if applicable) submitted by members, turning data submissions into data series, data-series-groups and data-series-sets, and processing them into comparative analytical reports as specified by members of said data sharing group.

(5) A Data-Discrepancy-Analysis tool, that optionally and discretionally invokes data processing algorithms, external knowledge-bases and human domain-expertise to reveal/interpret temporal or probabilistic features of data series, contrast between data series based on such features, aggregate them into data-series-sets sharing similar features, user-objectives etc., and associatively tag such sets, groups or individual data series with names such as respective user-group names, analysis type names, entity names, data characteristic names etc. before archiving into easily searchable data bases.

(6) An optional, user-interactive component of the Data-Discrepancy-Analysis tool that overlay as a cursor, buttons or soft-menus on the graphics presented on client devices, to select a region of interest on data space displayed and launch data disparity analysis procedures at users' discretion.

(7) An optional data search tool, which is a software algorithm residing on any machine connected to the same network that couples the client devices and server machines discussed above, and able to search for a certain type of numerical trend within a data series, a numerical relationship between multiple data series, data-series-groups or data-series-sets, or name-tags associated with them

An important objective of the present invention is providing a tool to internet users to source relevant information directly from affected personnel, rather than corporate websites, media channels or third-party reports, thus making the collected data more reliable.

Another objective is forcing-in at least one independent parameter (such as a time measurement) along with data (the dependent parameter) submissions, at the data-source itself, thereby providing an additional Degree Of Freedom for data search engines to work with. For example, allowing data inputs only within a range of timestamps from participants eliminates any chance of bringing up time-obsolete data in subsequent searches.

Also an important objective of the invention is making use of the infrastructure of existing social networks to facilitate data collection, so that many necessary components doesn't need to be built from the scratch.

Thus, another objective achieved here is merger of social networks and web search engines in a data-centric pursuit. The search engine disclosed here is optimized to sniff out dependent data that are functions of independent variables or other dependant data in a prescribed manner.

Also it is an objective to provide ordinary people the ability to run their own, custom designed market surveys, campaigns or opinion polls in an inexpensive manner.

Yet another objective is to provide governments, non-profits, NGOs etc a tool to quickly solicit information or feedbacks from a targeted community, for administering social development projects etc.

Intent of this invention is also to provide a tool to share engineering data between engineers working on similar projects.

This tool and method also provides internet users with a way to monetize their ‘life-data’, by selling such data while maintaining full control over the information transacted.

This tool and method also seeks to provide opportunities for placing context-relevant, revenue generating advertisements placed on user interfaces of said client machines.

### DRAWINGS

### Figures

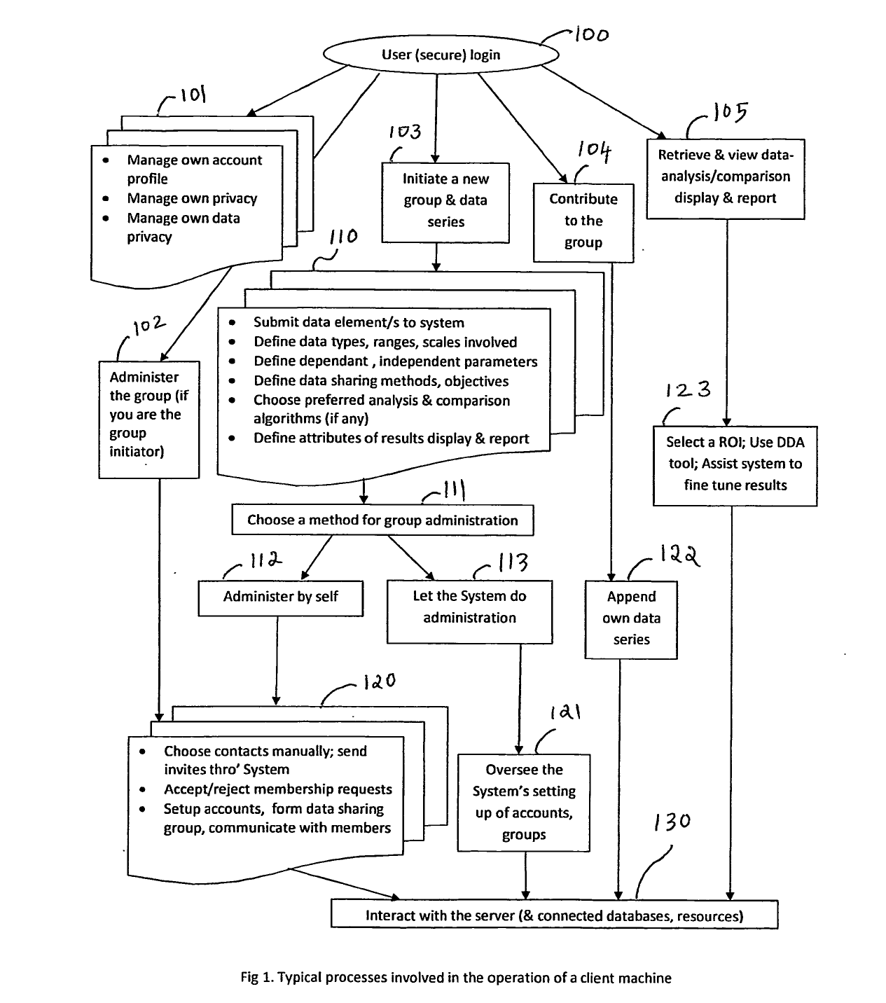

FIG. 1 shows typical processes involved in the operation of client machines.

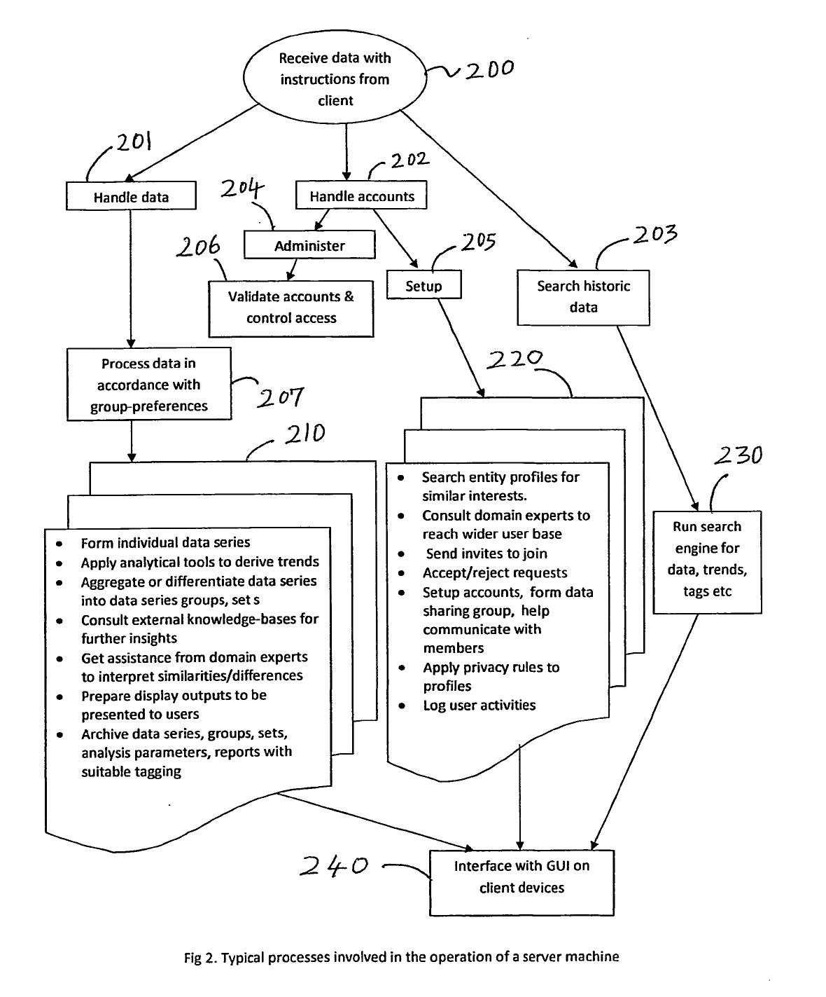

FIG. 2 shows typical processes involved in the operation of server machines.

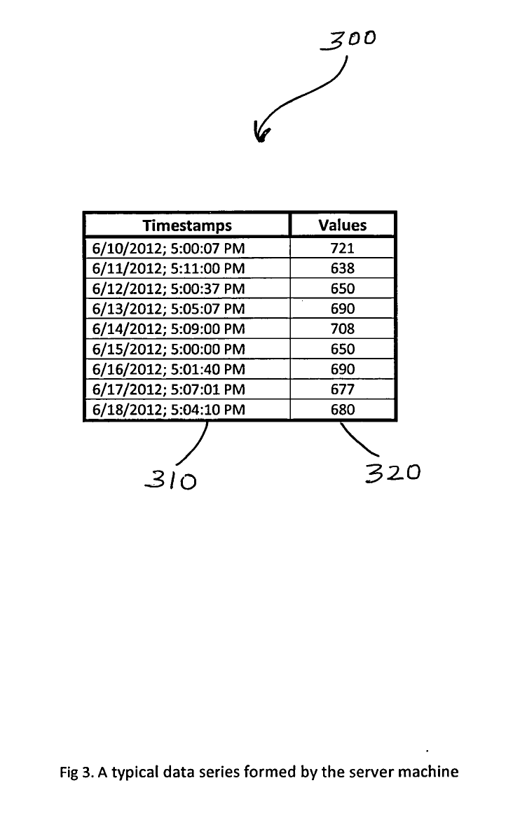

FIG. 3 is a typical data series formed by the server machine.

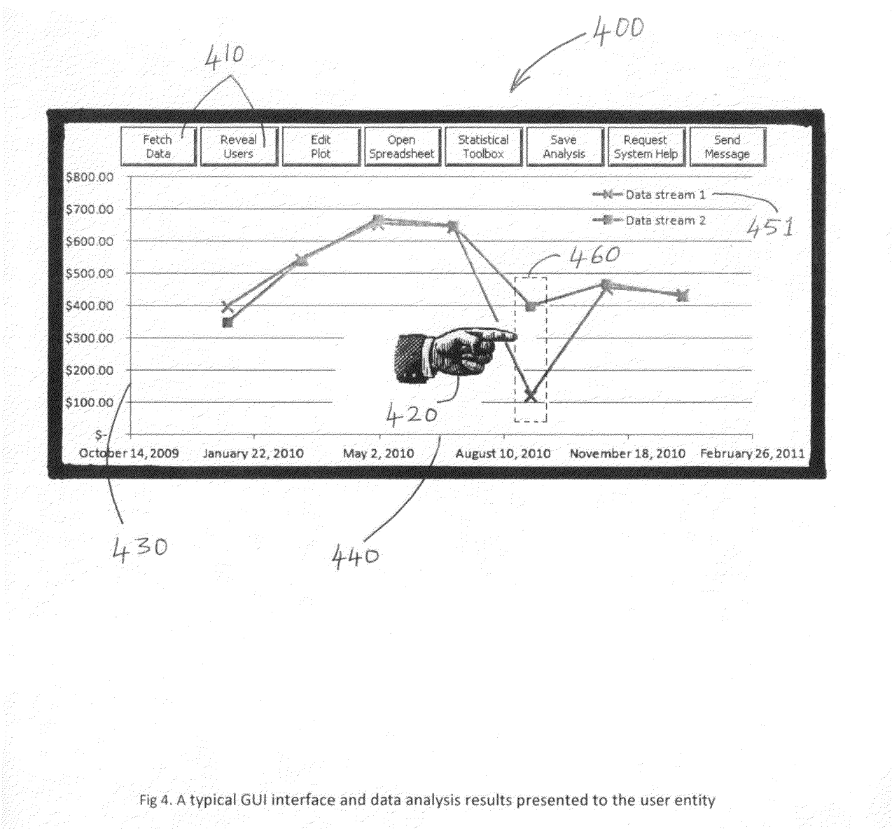

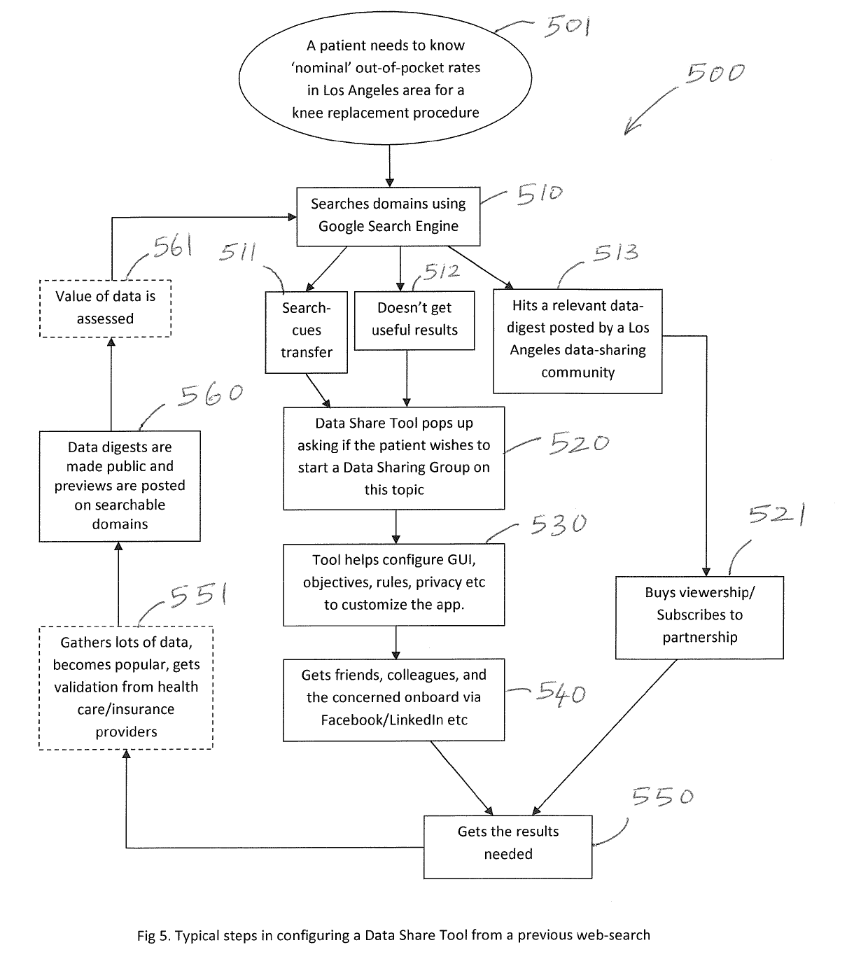

FIG. 4 is a typical GUI interface and data analysis results presented to the user entity.

### DETAILED DESCRIPTION

The invention disclosed is a system to solicit & gather voluntarily-submitted data elements from networked entities, analyze temporal & probabilistic natures of such data, administer data analytics (which includes running algorithms, tagging, grouping, archiving and retrieval of data structures) and produce analytic displays per user requirement. The system preferably has a client-server architecture, where the client devices host client software that facilitates data submission by individual-entities. The client devices transmit said data to at least one central, communicatively coupled server machine, which runs a server software. The server machine enabled by said server software can analyze, interpret and compare data structures by using statistical tools, consulting external databases, launching data-search algorithms or invoking human's domain-expertise if necessary. The server machine also produces text, graphics and report-objects interactively, on client devices. Besides, the client and server machines communicate via network to accommodate user preferences, adjust privacy settings, launch e-mail campaigns etc.

### Operation—FIGS. 1, 2, 3 and 4

FIG. 1 illustrates the processes involved in the operation of a client device or client machine. The processes shown do not form a flowchart, and may not happen in the order depicted in the figure. Central to the embodiment of the tool disclosed, is a user friendly app (software application) that can be downloaded and launched on smart phones, portables, PCs etc. Such an app and its icon could exist independently, or be embedded into an existing social networking application that the user is a member of. In the case of a stand-alone app, a first time user will be asked to setup an account and register a profile. A person signing up with the tool may not necessarily have a singular data sharing objective. However, much of his/her current data interests should be indicated in the profile, so that the tool will automatically be able to find him/her whenever there's a need for matching data donors to subscribers.

A user whose profile is registered with the tool (or system), is allowed a secured login means 100 as shown in FIG. 1. Further on, the user can initiate a new data-sharing-group (thereby start posting data) 103, contribute data 104 to the group in which he/she has been accepted as member, manage own account 101, administer 102 the group (if entitled) or view 105 data analysis displays. A user wanting to start a data-sharing-group would define 110 the dependent and independent parameters involved in a typical data submission, specify ranges, units and scales of such parameters and describe the method/objective of the data comparison project proposed. The user would then choose 111 between forming a data-sharing-group all by himself/herself 112 or requesting the system 113 to help find entities having similar data sharing objectives. In either case, a range of individuals or institutions will be solicited 120 via various types of media (typically email, social network etc) by the system to participate in the data sharing project, and the incoming registrants will be screened by the system, the group initiator and domain experts called-in by the system (if any).

An entity who is already a participant in the data sharing group, would login, contribute data 104 or view analytical results 105 as he/she chooses. He/she also has option 123 to request a custom discrepancy analysis by picking relevant data structure components, zooming into a region of interest 460 of a displayed graphics using the Data-Discrepancy-Analysis (DDA) tool 420 of FIG. 4, clicking on soft-buttons 410 or launching soft-menus.

The data elements submitted by users belonging to a certain data-sharing-group will be of the same type. Besides, the independent parameter elements (if any) submitted along with the data elements will also be of the same type.

Depicted in FIG. 2 are typical processes involved in the operation of a server machine. It accepts 200 data, instructions related to processing such data and preferred formats for reporting analysis results. The server machine runs the server software that has several modules and functions. For example, its account management function 202 has the ability to establish new accounts and authenticate user access 206. Also it can search and match user profiles available on the public internet or other data sharing groups for common interests in data sharing, for the purpose of forming 205 new data sharing groups. It also can augment this task 220 by sending out invites (such as emails & social network posts) to people it found by its matching algorithm or to those chosen by the group initiating member or the ones suggested by a domain experts. It can do a whole gamut of group administrative functions such as disqualifying users, relaying communications between users, applying differentiated privacy control parameters across various domains, log user activities etc.

The data processing module 201 receives data from members of data sharing groups and sorts them into suitable data structures. FIG. 3 depicts a typical data series 300 comprising of a first column 310 of independent parameters and a second column 320 of corresponding dependent parameters. In FIG. 3., the dependent parameter listed in the 2^{nd} column is a measurement in arbitrary units, taken at instances of a timestamp (the independent parameter) listed in the 1^{st} column. Depending on the scope of the data sharing project, there could be multiple dependent and independent parameters per data element submission. The server software is also a mathematical engine that processes 210 elements as well as single or multi-dimensional arrays of dependent and independent parameters forming such input data. Depending on users' data processing/sharing objectives, the module can launch suitable mathematical tools to characterize, filter, compare, contrast and sort members of said data-series-group into sets that exhibit similar temporal or probabilistic traits. Also, this module is designed in a way that, domain experts can access, interact and direct the modules' data processes in a desired manner. At the discretion of user groups, the module can also tag and archive the data structures involved, sub arrays or elements of a said data structures, sorted sets of data elements or data analysis reports using search-friendly, descriptive labels. The data processing module is also responsible to generate interactive graphic displays depicting data analysis results in accordance with user's output preferences. The server machine sends 240 such graphics to the client machines, gets interactive inputs from users via GUI interfaces of the client and re-computes said displays to user satisfaction.

### Search Engine Operation:

Another part of the tool in FIG. 2., is a search engine module that can mine 203 data archives (subject to read permissions set) for parameter types, numerical properties, dynamic events, filters used, analysis performed etc., associated with raw or processed data. For example, the search engine could make 230 user-assisted queries for a certain type of relationship between multiple data series, a certain temporal or probabilistic trait in a data series' dependency on an independent parameter, association of a data series with a user group, individual-entity, data sharing objective or analysis report etc. To illustrate further, a user can search for a data series in the archives that has a correlation coefficient greater than 0.8 with a given series. Or he/she could isolate those series containing a spike event in the dependent parameter, within a certain time bracket. In yet another example, the engine could bring up investments having similar risk exposure, but showing less volatility (variance) than a particular data series being analyzed. Another example is where existence of data sharing groups having similar objectives or past participation of a certain entity in other data sharing groups can be queried.

The server software is also responsible for driving a graphical user interface (GUI) 400 on the client machine that presents compiled data, analysis results etc. to members of the data sharing group. Such graphs could be temporal plots, histograms, pi-diagrams, frequency charts etc and may be labeled 451 using pseudo names to protect privacy of the data-contributor, if needed. Such graphics may also be optionally overlaid with a Data-Discrepancy-Analysis (DDA) tool 420 described below. The DDA tool has at least one cursor, several optional, pre-configured, soft buttons 410 and menus laid out on the GUI that enable quick manual retrieval and processing of data chosen by the user.

### Operation of DDA Tool:

Components of Data-Discrepancy-Analysis tool are optionally displayed on the GUI of the client device, overlaid on graphical results. When the cursor is used to select a Region Of Interest (ROI) 460 on displayed graphics 450 or pick a data series, the system processes the data selected to display several statistical parameters associated, which gives further insight into trends and discrepancies hidden in the selection. Further by invoking buttons and soft menu, the user can launch quick calculations or seek advanced help from resources such as knowledge bases (say Wall Street Journal, National Geographic or NASA archives) or domain experts to interpret a trend or discrepancy.

The DDA cursor tool can also be used as a selection tool to pick data elements from a displayed plot or table for selective processing, or as a pan-zoom tool.

### Data Types Handled by the Tool:

A broad variety of data can be handled by the system. Generally, every data element submitted to the system has a dependent parameter defined in relationship with an independent parameter. Though most of the time, the dependent parameter is a numeric (such as, a temperature, commodity price etc), it need not necessarily be a quantifiable measurand at all. For example, it could be a relativistic expression (such as ‘hotter’, ‘cold’ etc) or a Boolean (true or false states). The data could be a string such as, one describing a color, a shape etc. Also, it need not be digital or be generated by a machine. An appropriate example would be user's personal feelings or thoughts (anger, sadness etc.). Accordingly, a data element could also be submitted without an associated independent parameter. In such cases, data elements are processed by the system in association with their respective indices.

### CONCLUSIONS, RAMIFICATIONS AND SCOPE

While my above description contains specificities in the architecture of the tool, these should not be construed as limitations on the scope, but rather as an exemplification of several embodiments thereof. For example, the server software, client software and search engine modules might overlap, reside on the same computing platform or be distributed among several clients, servers and networks.

Further, the intended purpose of this tool may change according to the context of data types, acquisition and usage. In one possible variation, the data collected may not be for the purpose of comparison at all. An example of such a situation is when the tool is configured to run an opinion poll in a community where a singular agency collects one independent parameter (opinion) each, from every person and the resulting data structures are not made available to the data-contributors. In another variation, the tool may be used by a lone individual-entity for the purpose of recording of events or parameters for his/her own archival and analysis purposes, and not sharing such data with anyone else.

Accordingly, the scope should be determined not by the embodiments illustrated, but by the appended claims and their legal equivalents.

1-21. (canceled)

22. A computer based tool to share information submitted by individual entities and pertaining to topics of common interest, comprising:
a. at least one client machine, communicatively coupled with at least one server machine and interactively coupled with at least one of said individual entities operating said client machine,
b. said server machine communicatively coupled to at least one of a plurality of said client machines, any other server machines and administrative means,
c. at least one of said topics of common interest shared by said individual entities, operating said client machines and participating in information sharing,
d. at least a first member of a plurality of attributes belonging to said topic of common interest, that can be quantified, converted into digital information and inputted into said tool such as, but not limited to, a characteristic of an object, a measurable aspect of an event, an opinion having finite logical states etc.,
e. at least a second member of said plurality of attributes belonging to said topic of common interest, that can be associated with at least a said first member attribute as a basis of comparison such as but not limited to, a time stamp at which said first member attribute was recorded, a location stamp at which said first member attribute was reported, an index distinguishing a certain element of said first member attribute from the rest of elements of said first member attribute etc.,
f. a first user interface means on said client machine to accept at least one data element representing at least a said first member attribute, along with any other submitted data element representing at least any said second member attribute associated with said first member attribute of said topic of common interest,
g. a second data collecting means on at least one of said server machines to gather data elements accepted by at least one of said client machines representing at least a said first of said plurality of attributes along with any other submitted data elements representing associated attributes, pertaining to said topic of common interest and accepted by said client machine,
h. a third data processing means on at least one of said server machines to process said data elements collected by said server machines in accordance with object methods and object properties defined for classes to which said attributes belong such as but not limited to, data contributor profiles, common interest topic profiles, data attribute profiles, privacy control parameters, analysis algorithm requirements, subject-expertise needs, data ownership strategies etc.,
i. a fourth data displaying means on said client machines to accept processed information pertaining to said topics of common interest from at least one of said server machines, such as but not limited to data structures, data trends, data interpretations, data graphing requirements, graph labeling attributes, information-filter settings etc., interact with said individual entities operating said client machines regarding their personal data-viewing choices and display said information on said client machines in a manner required by said individual entities,
thereby providing said individual entities easy access to most relevant crowd-sourced data, personalized data analysis reports, insightful expert digests, and customizable data-search tools in a cost effective manner.

23. Computer based tool of claim 22 wherein said data element representing a member attribute belong to data-types such as but not limited to number, character, logic level, relationship, opinion, implication, cluster of information, array of information etc.

24. Computer based tool of claim 22 wherein, an individual entity is a person, an institution, as well as a group of persons.

25. Computer based tool of claim 22 wherein, said participating individual entities consist entirely of a single individual entity.

26. Computer based tool of claim 22 wherein, said topic of common interest does not explicitly have an attribute that can be associated with at least a said first member attribute chosen to be shared between participating entities in which case, said computer based tool generates appropriate associative attributes required by said first user interface means, said second data collecting means, said third data processing means and said fourth data displaying means to enable information comparison sought by said participating individual entities.

27. Computer based tool of claim 22 wherein functionalities of said first user interface means, said second data collecting means, said third data processing means and said fourth data displaying means are implemented on systems having a non-client-server topology such as but not limited to peer-to-peer networks, stand alone architecture, etc.

28. Computer based tool of claim 22 wherein integrity of said data elements accepted by said client machines is enforced by mechanisms such as, but not limited to, access control via user authentication, admittance control through peer references and background checks, data integrity control through self-undertakings and data-vetting by mutually trusted intermediaries.

29. Computer based tool of claim 22 wherein privacy of said data elements, its derivative products and personal profiles of said individual entities participating in data sharing projects are administered according to privacy preferences set by said individual entities.

30. Computer based tool of claim 22 wherein trading of data assets and their derivative products such as but not limited to, raw & processed data, data validations, data interpretations, trend prognosis, analytics, reports, expert opinions etc are administered according to value propositions set by stake holders including said participating individual entities.

31. Computer based tool of claim 22 wherein said third data processing means on said server machines comprise of means including to compile, serialize, tabulate, name, tag, characterize, archive and retrieve data structures formed from said data elements contributed by said individual entities.

32. Computer based tool of claim 22 wherein said third data processing means on said server machines comprise of analytical tools that can compare, contrast, assimilate and segregate data elements and data structures based on their features such as but not limited to, temporal and probabilistic characteristics.

33. Computer based tool of claim 22 wherein said third data processing means on said server machines comprise of search algorithm means that can sift through data archives for behaviors such as but not limited to statistical trends, temporal trends, periodicity trends etc., of at least a said first member attribute with respect to at least a said second member attribute.

34. Computer based tool of claim 22 wherein said first user interface means, said second data collecting means, said third data processing means and said fourth data displaying means are customized to handle only specific attributes belonging to specific topics of common interest such as but not limited to, investment performance, local commerce, personal health, social violence, public utilities and higher education in association with parameters such as locales, time periods, social values, media penetration levels, natural divides etc.

35. Computer based tool of claim 22 wherein, said individual entities submit information in step with each other.

36. Computer based tool of claim 22 wherein, said individual entities share information through at least one commonly acceptable intermediary such as, but not limited to a credit card company, a utility company, a healthcare company or a bank, on said individual entities' behalf,

37. dependent claim 36 wherein said information is at least a said first member attribute pertaining to a certain type of payment made by said individual entities and known to said intermediary.

38. dependent claim 36 wherein said information is at least a said first member attribute pertaining to a certain type of earning made by said individual entities and known to said intermediary.

39. dependent claim 36 wherein said information comprising of data elements representing member attributes authorized to be shared by said individual entities, is based on transaction histories involving said intermediary such as, but not limited to billing statements, pay statements etc.

40. Computer based tool of claim 22 wherein, said topic of common interest and said attributes belonging to said topic of common interest, needed by said individual entity to build a possible data sharing group, are sensed by said tool by analyzing information such as but not limited to, key-words used in a web-search operation by said individual entity, algorithm employed in said web-search, a link clicked on a web page, successive links clicked-through from a web site, results from an interactive dialog with said individual entity etc., so that said tool can intelligently assist said individual entity in setting up said data sharing group.
